(19) United States
(12) Patent Application Publication
(10) Pub. No.: US 2026/0367719 A1
(43) Pub. Date: Nov. 19, 2026

(54) MODULAR ACCESSORY SYSTEM WITH WIRELESS INPUTS FOR PERSONAL COMPUTING DEVICES

(71) Applicant: Raven Resonance Inc., San Francisco, CA (US)

(72) Inventors: Ivan France, Saratoga, CA (US); Curtis Aumiller, San Jose, CA (US); Thomas Suarez, San Francisco, CA (US)

(73) Assignee: Raven Resonance Inc., San Francisco, CA (US)

(21) Appl. No.: 19/676,673

(22) Filed: May 13, 2026

Related U.S. Application Data
(60) Provisional application No. 63/806,467, filed on May 15, 2025.

(51) Int. Cl. G06F 3/038; G06F 1/16; G06F 3/0346; H02J 7/70; H02J 50/10; G06F 3/01; H04R 1/08

(52) U.S. Cl. CPC G06F 3/038; G06F 1/163; G06F 3/0346; H02J 7/731; H02J 50/10; G06F 3/017; G06F 2203/0384; H04R 1/08; H04R 2420/07

(57) ABSTRACT

A modular accessory system for personal computing devices having an accessory interface with at least one power and one data connection terminal, with one or more modular accessories configured to be selectively and removably attached to the personal computing device through the accessory interface and a corresponding accessory case. The modular accessories and/or accessory case include wireless communication components and an input mechanism enabling a user to wirelessly provide input commands and functions to the personal computing device. The personal computing device is smart glasses and the modular accessories are of a type comprising a battery module, a GPS module, a camera module, a microphone module, an activity tracker module, and/or a health monitoring module.

### RELATED APPLICATION

This patent application relates to and claims priority from U.S. Provisional Patent Application No. 63/806,467 entitled “Modular Accessory System with Wireless Inputs for Personal Computing Devices” filed 5/15/2025 and is incorporated herein by reference including its specification.

### FIELD OF THE INVENTION

The present invention is directed to a modular accessory system for personal computing and similar devices. The inventive modular accessory system preferably includes one or more detachable accessory modules with connections allowing for both power transfer and data transfer. The accessory modules are most preferably physically connected to the computing devices either by magnets or some other mechanical locking mechanism. Through such physical connection, the accessory modules are connected to the internal circuitry of the computing devices via induction or exposed pins – such as pogo or spring-loaded pins.

### BACKGROUND OF THE INVENTION

Personal computing devices come in many forms and functions. For example, personal computing devices may be wearable electronic devices, such as smart glasses, smart watches, and other devices that attach to or are worn by a user. In addition, personal computing devices may come in other non-wearable forms, such as GPS devices, cameras, microphones, activity trackers, health monitors, etc. Regardless of the specific form, such personal computing devices have become much more common in recent years. With the increase in numbers and users, the need for powering such devices and the use of various accessories with such devices is paramount, particularly continuously powering such devices without interruption. In addition, with the increased use of accessories for such electronic devices, the monitoring and maintenance of such modular accessories is vital.

Under current technology, users often must shut-down personal computing devices and/or remove most wearable devices in order to replace or recharge the power source. For example, most wearable devices like smart glasses or smart watches must be re-charged by placing them in a docking station or similar cradle because such batteries are usually internally mounted and not easily removed. In addition, if a user wants to replace a battery on such a wearable device, the device typically needs to be shut-down or restarted, because the power needs to be completely disconnected. Similar considerations must be accounted for with other devices, such as GPS, cameras, microphones, activity trackers, health monitoring, etc., whether stand-alone or as an accessory to another device.

In addition, with the increased use of accessory modules on personal and wearable electronic devices, it has become ever more important to track type and usage characteristics of the same types of accessories. For example, for a particular rechargeable battery, important information relevant to its performance include, but is not limited to: chemistry type, energy density, cycle life, self-discharge rate, operating temperature, internal resistance, among others. Similar for other devices like GPS, cameras, microphones, activity trackers, health monitoring, etc., type and usage characteristics and data is also important.

Current accessory designs for personal computing devices suffer from limited battery life, restricted input methods, and bulky form factors. By distributing functionality across modular components, this invention addresses these limitations while providing enhanced user interaction capabilities.

Accordingly, there is a need for an improved modular accessory system for personal computing devices that allows for continuous, uninterrupted use during recharge, and also allows for monitoring and tracking accessory features and usage characteristics. The present invention fulfills these needs and provides other related advantages.

### SUMMARY OF THE INVENTION

The present invention has been developed in response to the present state of the art, and in particular, in response to the problems and needs in the continuous, uninterrupted use and operation of personal computing devices, particularly wearable electronic devices. Such invention relates to a system and configuration of modular accessories, including but not limited to batteries, that allow for replacement or “hot-swapping” of one or more accessories while the electronic device is in continuous use or operation. In particular, for smart glasses or similar wearable electronic devices, a system of batteries and power management that allows for replacing a depleted (or nearly depleted) battery with a fully charged battery without interruption of operation or even use of the wearable devices, i.e., while wearing the smart glasses. Similarly, for other personal computing devices or accessory modules that function with wearable electronic devices, a similar switching or replacement of accessories without interruption of operation or use is achievable.

For example, when such modular accessories are rechargeable batteries, each modular battery can be located anywhere on the personal computing device. In the case of wearable devices like smart glasses, one or more batteries may be attached to the stems or temple arms of the glasses, i.e., behind the ear, one on each stem. Such attachment may be either mechanically or magnetically. Each modular battery can be added or removed by a user at-will and in a “hot-swappable” fashion, meaning the device can keep itself powered on even when one modular battery is disconnected. This “hot-swappable” feature may be achieved by only disconnecting one battery at a time or by incorporating a capacitor or other short-term storage capacitor internal to the wearable device. Similarly, such “hot-swappable” modular batteries may also be configured to work with stand-alone personal computing devices, like GPS devices, cameras, microphones, activity trackers, health monitors, and similar devices. In addition, with wearable devices like smart glasses or smart watches, the modular accessory system may include not only modular batteries but also modular accessories that add functionality such as GPS modules, camera modules, microphone modules, activity tracker modules, and health monitor modules, among many others.

The modular batteries can be removed and charged external to the personal computing devices, allowing modular batteries to be quickly swapped out without requiring the user to shut down or switch to a different personal computing device. For example, when the device is a pair of smart glasses, this may mean uninterrupted work or other usage, as well as continued utilization of prescription lenses, hearing assistance, or similar features. When removed or swapped, the modular batteries may be recharged in a pocket-sized carrying charging case, as opposed to the entire case or docking station for the complete glasses frame. Alternatively, the modular batteries may be charged on a base station or similar platform.

The primary components of the herein described inventive modular accessory system for electronic computing devices include: the personal computing device, individual swappable accessory modules, and a storage case. Each component of the system preferably can communicate wirelessly with the other components and may also communicate with the user’s mobile phone associated with personal computing device. Such wireless communications preferably occur by traditional methods such as wi-fi, Bluetooth, or alternative novel wireless communication protocols yet to be discovered.

In this configuration, the components of the inventive system can act as wireless inputs for the other components, primarily the main computing device, whether a wearable device such as smart glasses or a smart watch, or stand-alone devices like GPS devices, cameras, microphones, activity trackers, health monitors, and similar devices. The accessory modules may include modular batteries, or other accessories such as GPS modules, camera modules, microphone modules, activity tracker modules, and health monitor modules, among many others – configured to be used with the main computing device. In any form of main computing device or accessory module, the storage case may include additional sensors such as a touchpad, screen, inertial measurement unit (IMU), optical mouse sensor, scroll wheel, and/or button inputs as a wireless controller for the CPU on the main computing device.

The modular accessories may also send data wirelessly, particular when they contain other operational components such as a microphone, where an individual battery module can function as a detachable lavalier microphone for the user. The modular batteries may also contain their own IMU sensor or similar functional component. The IMU sensor can operate as a controller for the main computing device, including orienting the same for pointing, detecting IMU gestures for on-screen selection, or additional buttons/switches, particularly in conjunction with a corresponding accessory module.

The present invention is directed to a modular accessory system for a personal computing device, such system including a personal computing device with a processor, one or more modular accessories configured to be selectively attached to and detached from the personal computing device, one or more connection terminals on each of the one or more modular accessories providing at least one data connection to the personal computing device when a modular accessory is attached, and an accessory input device having a wireless transmitter component configured to wirelessly transmit input data to a wireless receiver component in at least one of the modular accessories, wherein the at least one of the modular accessories communicates the input data to the processor of the personal computing device. The modular accessory may further include an accessory storage case configured to store at least one of the one or more modular accessories, wherein the accessory storage case comprises the accessory input device configured to function as a wireless input controller for the processor of the personal computing device.

The personal computing device is preferably a wearable electronic device, including a pair of smart glasses, wherein the one or more modular accessories are attached to one or more temple arms of the smart glasses. At least one of the one or more modular accessories may be one of a modular battery configured to provide power to the personal computing device, and an inertial measurement unit (IMU) configured to provide motion-based control input to the personal computing device. At least one of the one or more modular accessories includes a microphone configured to function as a detachable lavalier microphone that wirelessly transmits audio data to the personal computing device.

The accessory input device may include one or more of a touchpad, a display screen, an inertial measurement unit, an optical mouse sensor, a scroll wheel, one or more buttons, or one or more switches. The inertial measurement unit preferably detects orientation and movement of the accessory input device in three-axes and translates such orientation and movement into wireless input commands for pointing and selecting functions on personal computing device. The accessory storage case is configured to charge at least one of the modular accessories via near-field inductive charging or physical electrical contact while the at least one of the modular accessories is stored in the accessory storage case.

In another embodiment, the present invention is directed to a modular battery system for a personal computing device. The personal computing device has a processor and a power management circuit. A plurality of modular batteries are configured to be selectively attached to and detached from connection terminals on the personal computing device. The power management circuit is in communication with each of the plurality of modular batteries when the same are attached to the personal computing device and is configured to selectively draw power from each of the plurality of modular batteries to optimize battery lifespan. Each of the plurality of modular batteries includes a wireless receiver component configured to receive input data for the personal computing device and communicate the input data to the processor. A battery storage cradle is configured to charge each of the plurality of the modular batteries and includes at least one accessory input mechanism having a wireless transmitter component configured to wirelessly transmit input data therefrom to the wireless receiver component in at least one of the plurality of modular batteries.

The power management circuit is configurable in a battery lifespan extending mode in which power is drawn alternately or in parallel from at least two modular batteries so as to deplete the power more uniformly. The power management circuit prevents depletion of any one of the at least two modular batteries below a predetermined charge threshold while charge remains available in another of the at least two modular batteries. Each of the plurality of modular batteries includes a printed circuit board with a microcontroller and a fuel gauge integrated circuit configured to track charge cycle count and store usage data in on-board memory. The usage data may be communicated to the power management circuit to provide battery usage recommendations to a user.

Wireless communication between the wireless transmitter component and the wireless receiver component occurs via at least one of LAN, Wi-Fi or Bluetooth. The at least one accessory input mechanism is configured as a wireless controller comprising at least one of a touchpad, a touchscreen, a display screen, an inertial measurement unit, an optical mouse sensor, a scroll wheel, one or more buttons, and/or one or more switches. At least one of the plurality of modular batteries includes an inertial measurement unit (IMU) configured to provide gesture-based or orientation-based control input to the processor of the personal computing device.

In another embodiment, the present invention is directed to a modular accessory system for smart glasses. The system includes smart glasses containing a central processing unit and a display, one or more modular accessory devices configured to be selectively attached to and detached from one or more temple arms of the smart glasses, one or more connection terminals on each of the one or more modular accessory devices providing at least one power connection and at least one data connection to the central processing unit in the smart glasses, and an accessory storage case configured to store and charge the one or more modular accessory devices and comprising at least one input mechanism configured to function as a wireless input controller for the CPU of the smart glasses. Each of the one or more modular accessory devices includes power storage cells and a wireless communication component configured to wirelessly communicate with both the at least one input mechanism and the central processing unit.

Each modular accessory device is attached to the smart glasses by at least one of a magnetic connection or a mechanical locking mechanism, and the power connection and the data connection are established via inductive coupling or spring-loaded contact pins. At least one of the one or more modular accessory devices includes a microphone, such that the modular accessory device is configured to function as a lavalier microphone that wirelessly transmits audio data to the CPU of the smart glasses. At least one of the one or more modular accessory devices or the accessory storage case includes an inertial measurement unit (IMU) configured to enable pointer orientation for the display of the smart glasses, detect gesture inputs for on display selection, or provide motion-based input commands to the CPU.

The at least one input mechanism of the accessory storage case comprises one or more of: a touchpad, a touchscreen, a display screen, an inertial measurement unit, an optical mouse sensor, a scroll wheel, one or more buttons, and one or more switches. The smart glasses, the one or more modular accessory devices, and the accessory storage case are each further configured to wirelessly communicate with a mobile computing device associated with a user of the smart glasses.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is a perspective, solid-form view of an embodiment of a personal computing device, e.g., smart glasses, embodying the present invention;

FIG. 2 is a top plan, view of the smart glasses of FIG. 1;

FIG. 3 is a close-up perspective view of an accessory module, e.g., proximate to a temple arm of the smart glasses according to the present invention;

FIG. 4 is a perspective view of the smart glasses of FIG. 1, showing a first accessory module attached to a temple arm and a second accessory spaced apart from another temple arm;

FIG. 5 is a system view of a modular case, battery housing, and smart glasses;

FIG. 6 schematically illustrates an accessory case incorporating an input mechanism.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element’s relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes and configurations of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention described herein is primarily concerned with a modular accessory system that may include at least three primary components, as follows: (1) a personal computing device (such as a wearable device, i.e., smart glasses or smart watch; or stand-alone devices, i.e., GPS, camera, microphone, activity tracker, health monitor, among others); (2) one or more individual accessory modules (such as battery modules, GPS modules, camera modules, microphone modules, activity tracker modules, and health monitoring modules); and (3) an accessory storage case. Each component of the system can preferably communicate wirelessly with the other components and may also communicate with the user’s mobile phone or other mobile computing device associated with the personal computing device. Such wireless communications preferably occur by traditional methods such as LAN, Wi-Fi, Bluetooth, or alternative novel wireless communication protocols yet to be discovered.

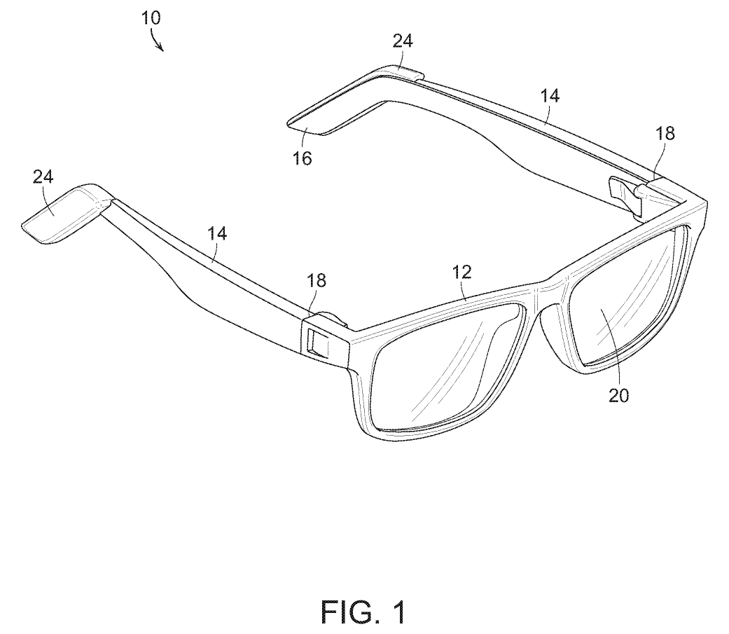

The present invention is directed to a system of modular accessories for personal computing devices. FIGS. 1-6 generally show the personal computing or wearable electronic device as smart glasses, including swappable modular accessories in the form of batteries. While the following description primarily focuses on smart glasses and related modular batteries, the modular system of the present invention has broader application for various forms of accessories that are used with a variety of personal computing devices.

In the embodiments described herein, the electronic devices are described as smart glasses, but may also comprise other forms of stand-alone personal or wearable computing devices, including but not limited to GPS devices, cameras, microphones, activity trackers, health monitors, and similar devices. Similarly, while the embodiments of modular accessories are primarily described as swappable batteries, they may also comprise other modules, including but not limited to GPS modules, camera modules, microphone modules, activity tracker modules, and health monitor modules.

Further, the present invention is concerned with a modular accessory system for personal computing devices, including but not limited to wearable devices such as smart glasses. In the inventive system, the modular accessories may include battery modules, GPS modules, camera modules, microphone modules, activity tracker modules, health monitoring modules, etc. – and a corresponding case or cradle. The modular accessories further include wireless communication components that receive user input commands from accessory input devices or apparatuses, such as the case or cradle, and communicates such user input commands to the personal computing device either wirelessly or through physical data contacts. The modular accessories of the system may include one or more battery modules that are selectively removable from the wearable device in a manner where the device is continuously powered and/or usable, including during recharging, replacement, or hot-swapping of one or more of the battery modules. The terms “accessory module” and “modular accessory”, as well as “battery module” and “modular battery” when describing particular embodiments, (including plurals of the same) are used interchangeably throughout this written description and are intended to mean and refer to the same parts.

The accessory modules and the accessory storage case, when presented in the form of modular batteries and a battery case, are primarily concerned with power supply and management used in the personal computing devices, such as smart glasses and similar wearable technology. The same accessory modules, whether battery or otherwise, may also be used with other personal computing devices, such as stand-alone GPS, camera, microphone, activity tracker, and health monitor devices, among others. This disclosure is not necessarily concerned with the function and operation of the personal computing devices beyond the modular addition of power supply or accessory functions, and the wireless input communications, control and management of power supply, and accessory operation. Features such as display, audio/video, processing, and control of such devices are intended to conform to the current state of the art of such devices, or as such state of the art may develop in the future.

In the context of modular batteries, the accessory storage case may be in the form of a battery charging case. Whether as a battery charging case or in connection with one of the other forms of modular accessories, the accessory storage case may provide other functionality, i.e., user input, user control, IMU detection, or similar accessory functionality as appropriate.

Regardless of the specific modular accessory or accessory storage case, each can wirelessly communicate with the other elements of the modular accessory system, as well as a connected pair of smart glasses to which the modular accessories may be connected. In this system, in addition to at least two power connectors (one for power one for ground), each of the accessory modules may include one or more general purpose data connections for direct communication with the corresponding personal computing device or the accessory storage case.

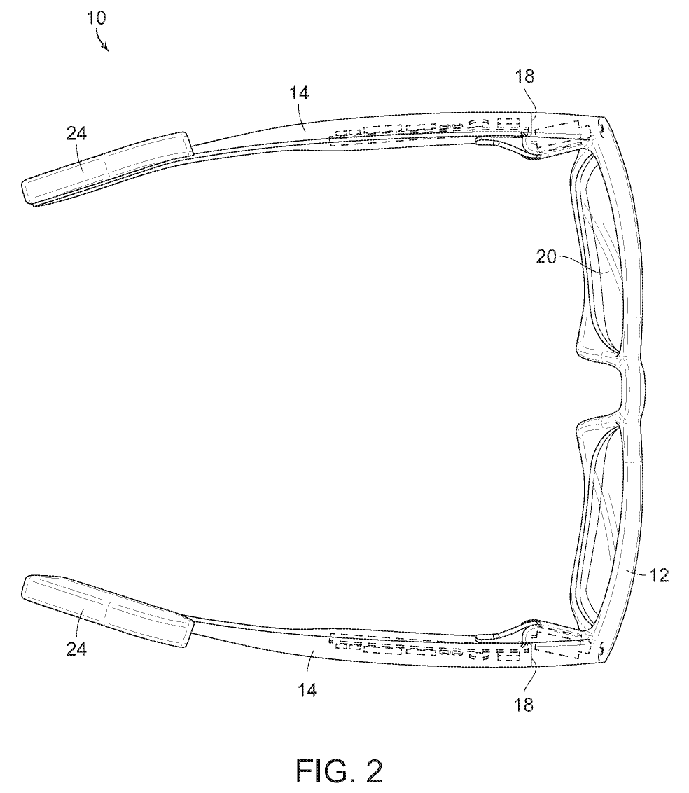

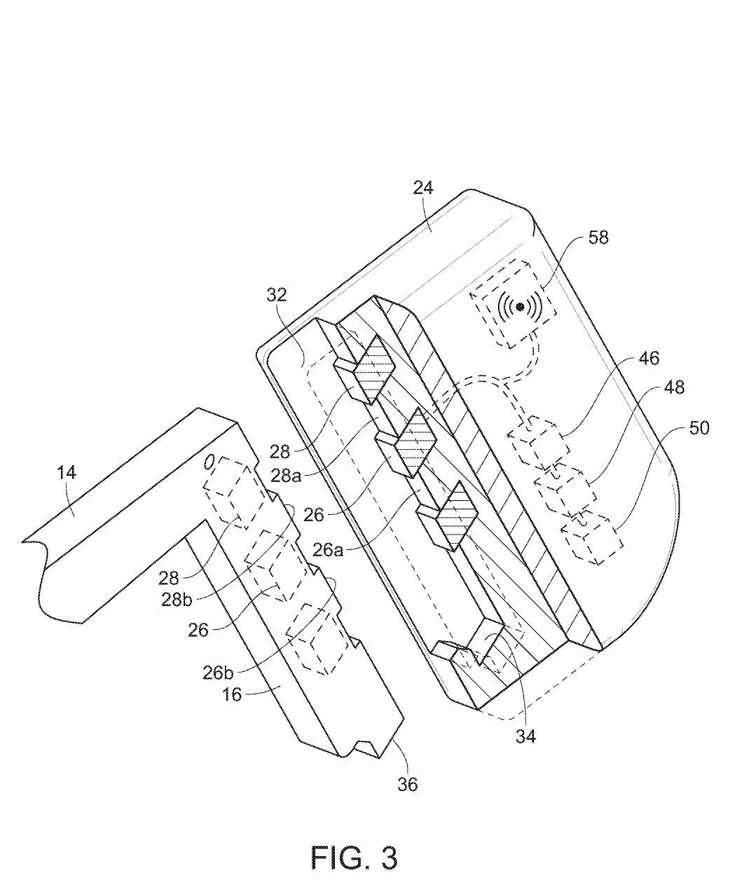

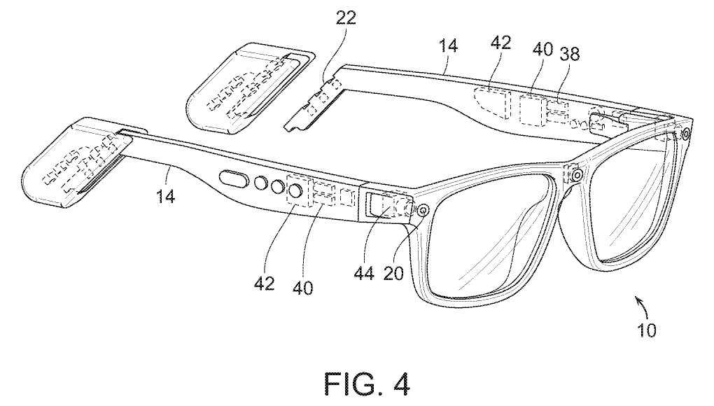

A particular embodiment of the personal or wearable computing device of the present invention is preferably in the form smart glasses 10, shown in FIGS. 1 and 2. Such smart glasses 10 have the typical features of a frame 12, temples or temple arms 14, temple tips 16, hinges 18, and lenses 20. In this embodiment, the temple tips 16 are preferably configured with battery receptacles 22 that receive battery modules 24. FIGS. 3 and 4 illustrate an embodiment where the battery modules 24 engage the temple tips 16, wherein the extreme ends of the temple tips 16 are configured to be inserted into a groove 32 on the battery module 24. The groove 32 has a depth configured to accept a sufficient portion of the temple tip 16 to provide stability to the connection. FIG. 3 shows in close-up the battery module 24 in spaced relation to the temple tip 16. FIG. 4 shows alternately one battery module 24 connected to the temple tip 16 and another battery module 24 in spaced relation to the other temple tip 16.

Corresponding elements of contacts 26 and 28 (electrical and/or physical contacts) are shown in schematic representations on the end of the temple tip 16 and in the slot 32 of the battery module 24. Such contacts 26 and 28 being in one or more form of mechanical, magnetic, inductive, conductive, or other known form of connection or attraction to achieve electrical and physical connection. In one embodiment, shown in FIG. 3, the corresponding electrical contacts 26 and physical contacts 28 preferably have mating recesses 26a/28a and extensions 26b/28b, that increase surface contact for improved electrical and physical connection. In addition, the groove 32 in each embodiment includes a notch 34 configured to receive a corresponding tab 36 on the temple tip 16 to provide additional securement and attachment.

In this embodiment shown in FIGS. 3 and 4, the battery module 24 engages and remains on the receptacle 22 from a posterior side, e.g., an end surface of the temple tips 16 extending along a portion of the temple tip 16 that is often positioned behind a user’s ear when worn – adding length to the temple arms 14. Alternatively, as shown in FIGS. 1 and 2, the battery module 24 and receptacle 22 are configured such that the same may engage and remain connected on a lateral side thereof, e.g., an inside or outside surface of the temple tip 16 extending toward or away from a center line of the frame 12. There is preferably a receptacle 22 and a corresponding battery 24 included on the temple tip 16 of each temple arm 14. In the embodiment shown, the form of the electrical contacts 26 and physical contacts 28 are schematically represented and understood to comprise one of the foregoing described forms.

FIG. 4 further illustrates a partially transparent view of the smart glasses 10 showing computing circuity 38, a power management circuit (PMC) 40, a back-up power source 42 and other elements contained within the frame 12 and/or temple arms 14. One such other element might include a camera 44, preferably disposed in the hinge 18 or front surface of the frame 12, adjacent to a lens 20. Although not shown in complete detail, it is understood that the computing circuity 38, power management circuit (PMC) 40, back-up power source 42 and other elements are internally connected by conductive wiring or similar technology, including connecting the PMC 40 to the electrical contacts 26 of the receptacles 22 on the temple tips 16.

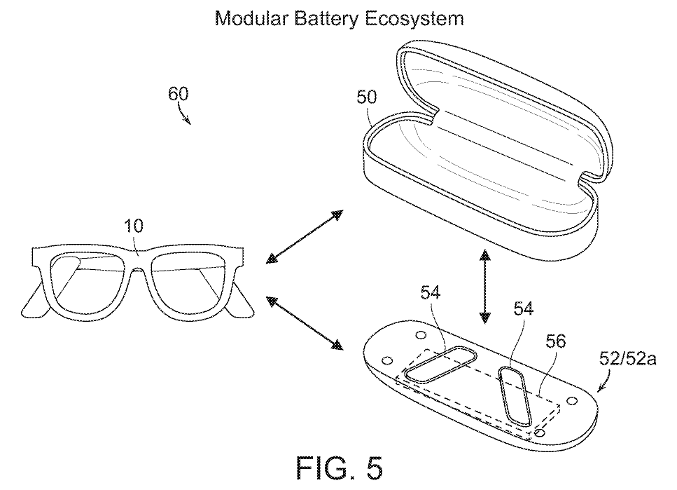

FIG. 5 illustrates an embodiment of a modular battery system (e.g., ecosystem) 60 for personal and wearable electronic devices of the type described herein that includes the device 10, a case 50, and an accessory cradle 52. The modular battery system 60 may wirelessly charge the modular batteries 24 as described above or charge the same through physical contact of electrical connections within the accessory cradle 52 removably stored in the case 50. Similarly, other accessory modules 24 may be charged (if they have on-board power storage) or otherwise transfer data regarding usage or maintenance when placed in such an accessory cradle 52. Similarly, other accessory modules 24 may also be removed and stored in a comparable case 50 or docking station/cradle 52 as described herein and may also wirelessly communicate with the other components as described above.

The particular embodiment shown is for use with smart glasses 10 and includes a glasses case 50 with an accessory cradle 52. The case 50 may be a simplified form of the case from the prior art, where charging or other electronic components may be independent of the case 50, preferably in the accessory cradle 52a. The accessory cradle 52a may be further described as an accessory charging cradle 52.

The accessory charging cradle 52 preferably includes two or more charging slots 54, each configured for receiving a 24 as described above, and a power storage cell 56. The power storage cell 56 is designed to hold a significant charge that can be transferred to individual modular batteries 24 placed into the charging slots 54. When placed into a charging slot 54, the modular batteries 24 may be recharged either by electrical connection with contacts 26 or 28 and corresponding contacts (not shown) in the charging slot 54 or by near-field or induction connection.

The power storage cell 56 of the charging cradle 52 may be recharged by wired connection to another power source or similarly by wireless near field or induction connection. In one embodiment, the case 50 may include electrical components – either contacts or contactless – that can recharge the power storage cell 56 when the same is positioned in the case 50.

In this configuration, two modular batteries 24 may be connected to the smart glasses 10 to provide power thereto, and two or more additional modular batteries 24 may be stored in the charging cradle 52 depending on the number of charging slots 54. When one or more of the modular batteries 24 connected to the smart glasses 10 are sufficiently depleted in charge, they may be swapped with one or more of the modular batteries 24 stored in the charging slots 54 on the charging cradle 52. In this way, the modular batteries 24 may be “hot-swapped”, meaning that one modular battery 24 may be replaced while a second modular battery 24 remains connected and powering the smart glasses 10 until a replacement modular battery 24 is connected. The “hot-swapping” system is designed to keep the smart glasses consistently powered and operational.

In addition to maintaining consistent power and operation of the smart glasses 10, another primary benefit of the swappable modular batteries is the preservation of battery lifetime. There can be multiple modular batteries 24 connected to a given personal computing device at any given time. Each of such multiple modular batteries 24 can have varying voltages depending upon how much charge each has at a given moment and its number of historical charge cycles, i.e., how many times a battery has been charged and discharged. Each modular battery 24 may be connected to its own small-printed circuit board (PCB) with a microcontroller and “fuel gauge” integrated circuit (IC) that tracks the cycles of that particular modular battery 24 by saving the information to EEPROM or other on-board memory storage.

Each modular accessory – whether battery or other – preferably has at its point of connection to the personal computing device multiple connection terminals, providing both power connections and additional general purpose data connections. FIGS. 3 and 4 show one preferred embodiment, in particular for use with smart glasses, schematically depicting three connection nodes within the modular accessory 24, adjacent to the side of the housing that connects to the smart glasses temple tip 16. The modular accessories 24 preferably include an assembly of circuitry 46, power storage cells 47, on-board memory 48, and additional hardware for unique functionality used to expand the capabilities by integrating new functionality into the modular accessories 24 themselves. The contacts 26 and 28 preferably include a minimum of two electrical connections – one for power and one for ground, as well as preferably at least one data connection that can access, among other components, the on-board memory 48. The on-board memory 48 is preferably configured to store data relevant to the particular modular accessory 24 and its performance.

The contacts 26 or 28 are preferably physically connected for power transmission, such as via induction or exposed pins, i.e., pogo or spring-loaded pins. Similar physical contacts 26 or 28 are preferably also used for data transmission as described. Alternatively, data transmission may occur wirelessly via antenna 58, e.g., LAN, Wi-Fi, near-field, Bluetooth, etc., with the wearable devices 10 or an associated external device, e.g., smart phone. For data transmission methods, data transmission may be wired via physical connection terminals, or optionally wireless data transmission capabilities to a wearable device (i.e., smart glasses); or associated smartphones or other compatible devices. For enhanced functionality options, the accessory modules or corresponding cases preferably include multiple input/output expansions, such as USB-C ports, SD card slots, headphone jacks, physical buttons, scroll wheels, touch input surfaces, haptic actuators, microphones, and/or cameras. In addition, extended device capabilities may include expanded storage or memory, extended-range antenna for Bluetooth or Wi-Fi, satellite (GNSS) positioning hardware, and/or additional wireless communication protocols.

In addition to the data connections, each modular accessory 24 preferably includes one or more wireless communication components 58 that are powered by and in communication with the operational components described above. In this configuration, the wireless communication components 58 of the modular accessories 24 or the accessory storage case 50 can act as wireless inputs for the other components, any one of the main personal computing device 10 (i.e., smart glasses, smart watch, or other devices), the modular accessories 24, and/or the accessory storage case 50. The accessory storage case 50 may include additional sensors or input mechanisms 62, including but not limited to a touchpad, a touchscreen, a display screen, an inertial measurement unit, an optical mouse sensor, a scroll wheel, one or more buttons, and one or more switches – all capable of functioning as a wireless controller for the personal computing device 10. The modular accessories 24 may also send data wirelessly, particular when they contain other operational components such as a GPS unit, a microphone, a camera, an activity tracker, a health monitor, and others. For example, an individual modular battery 24 that includes a microphone can function as a detachable lavalier microphone for the user. The modular batteries 24 may also contain their own IMU sensor or similar functional component. The IMU sensor, whether in the modular batteries 24 or the accessory storage case 52, can operate as a controller for the personal computing device 10, including orienting the same for pointing, detecting IMU gestures for on-screen selection, or additional buttons/switches.

Examples of additional functionality for use with modular accessories within this system, might include: (1) accessory modules with various input-output options, i.e., USB-C, SD card, headphone jack, buttons, scroll wheel, touch inputs, haptic actuators, microphones, or camera; (2) accessory modules with expanded device capabilities or sensors, expandable storage or memory, extended range antenna for Bluetooth or Wi-Fi, satellite (GNSS) positioning, or other wireless communication; or (3) accessory modules with pinouts in several forms – ideally about 6-8 pins for power, data, and additional sensor/communications functionality as may be needed or desired by the user.

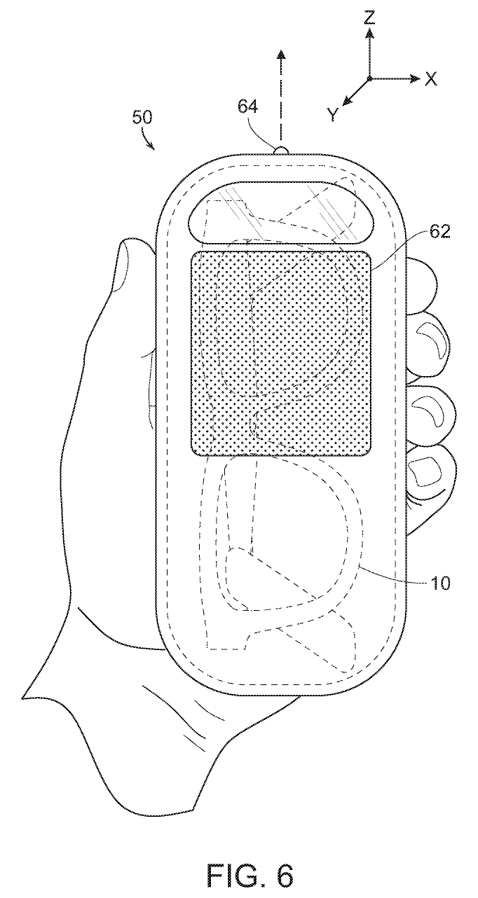

FIG. 6 illustrates a graphical depiction of an embodiment of an accessory storage case 50, including an input mechanism 62 in the form of a display screen, a trackpad, and/or an IMU-based pointer illustrated schematically by a three-axis pointer. For example, the accessory storage case 50 may include associated accelerometers, gyroscopes, and/or magnetometers to measure motion and orientation. The case may also include an emitter device 64 capable of emitting an IR, RF, or laser signal to interact with the personal computing device 10 and/or a separate component. In combination, those elements detect and calculate an object’s movement and position by combining data from multiple sensors to improve accuracy. The accessory storage case 50 may wirelessly communicate that orientation and motion information to the modular accessories 24 and/or personal computing device 10 for pointing and selecting functions as described.

As described, the inventive system 60 consists of three primary components that work together wirelessly to provide extended functionality. In the particular context where the personal computing device 10 is a pair of smart glasses, the glasses frame contains the main CPU 38 and primary display components 20, can receive wireless input from other system components, can communicate wirelessly with modular batteries 24 and the battery storage case 50; and processes data from sensors distributed across the system. The modular swappable batteries 24 provide power to the smart glasses 10 when attached, can function wirelessly to communicate data when detached therefrom, can communicate wirelessly with the smart glasses 10 and battery storage case 50, and may contain additional operational components, such as, microphone functionality enabling use as a detachable lavalier microphone. In addition, the modular batteries 24 may also include an inertial measurement unit (IMU) for motion-based control, and additional input buttons or switches. The battery storage case 50 may function as a storage and charging solution for the modular batteries 24, serve as a wireless controller for the smart glasses 10, and contain multiple input mechanisms 62 including: a touchpad interface; a display screen; an inertial measurement unit (IMU); an optical mouse sensor; a scroll wheel; and button or switch inputs.

The separate components of the system 60 can wirelessly communicate with each other and the user's mobile computing device 10 using established protocols such as LAN, Wi-Fi, and Bluetooth, as well as potentially novel wireless communication protocols developed in the future. The system's wireless communication capabilities enable novel use cases, as follows.

The system allows distributed input methods 62, where: the battery storage case 50 may function as a dedicated controller for the smart glasses 10, the detached modular batteries 24 may provide additional input options when separated from the smart glasses 10, and IMU sensors in both the modular batteries 24 and the battery storage case 50 enable gesture control and pointing functionality. When the modular batteries 24 include microphone functionality they allow for enhanced audio capture. The modular batteries 24 with integrated microphones may function as a detachable lavalier microphone, which can provide improved audio quality compared to microphones mounted on the smart glasses 10. The motion control associated with the IMU sensors enable pointer orientation for the glasses display, gesture detection for on-screen selection, and motion-based input commands.

The advantages of such an inventive modular accessory system 60 include: extended device functionality without significantly increasing the size of the main personal computing unit; hot-swappable power and operation solution eliminating downtime for charging or switching accessories; customizable functionality based on user needs and activities; future-proof design allowing for new module development without replacing the entire device; comprehensive accessory health monitoring and management; and/or authentication of compatible components to ensure system integrity.

Although several embodiments have been described in detail for purposes of illustration, various modifications may be made without departing from the scope and spirit of the invention.

1. A modular accessory system for a personal computing device, the system comprising:
a personal computing device having a processor;
one or more modular accessories configured to be selectively attached to and detached from the personal computing device;
one or more connection terminals on each of the one or more modular accessories providing at least one data connection to the personal computing device when a modular accessory is attached; and
an accessory input device having a wireless transmitter component configured to wirelessly transmit input data to a wireless receiver component in at least one of the modular accessories, wherein the at least one of the modular accessories communicates the input data to the processor of the personal computing device.

2. The modular accessory system of claim 1, further comprising an accessory storage case configured to store at least one of the one or more modular accessories, wherein the accessory storage case comprises the accessory input device configured to function as a wireless input controller for the processor of the personal computing device.

3. The modular accessory system of claim 2, wherein the personal computing device is a wearable electronic device, including a pair of smart glasses, wherein the one or more modular accessories are attached to one or more temple arms of the smart glasses.

4. The modular accessory system of claim 1, wherein at least one of the one or more modular accessories comprises one of a modular battery configured to provide power to the personal computing device, and an inertial measurement unit (IMU) configured to provide motion-based control input to the personal computing device.

5. The modular accessory system of claim 1, wherein at least one of the one or more modular accessories includes a microphone configured to function as a detachable lavalier microphone that wirelessly transmits audio data to the personal computing device.

6. The modular accessory system of claim 1, wherein the accessory input device comprises one or more of: a touchpad, a display screen, an inertial measurement unit, an optical mouse sensor, a scroll wheel, one or more buttons, or one or more switches.

7. The modular accessory system of claim 6, wherein the inertial measurement unit detects orientation and movement of the accessory input device in three-axes and translates such orientation and movement into wireless input commands for pointing and selecting functions on personal computing device.

8. The modular accessory system of claim 2, wherein the accessory storage case is configured to charge at least one of the modular accessories via near-field inductive charging or physical electrical contact while the at least one of the modular accessories is stored in the accessory storage case.

9. A modular battery system for a personal computing device, the system comprising:
a personal computing device having a processor and a power management circuit;
a plurality of modular batteries configured to be selectively attached to and detached from connection terminals on the personal computing device;
wherein the power management circuit is in communication with each of the plurality of modular batteries when the same are attached to the personal computing device and the power management circuit is configured to selectively draw power from each of the plurality of modular batteries to optimize battery lifespan;
each of the plurality of modular batteries comprising a wireless receiver component configured to receive input data for the personal computing device and communicate the input data to the processor; and
a battery storage cradle configured to charge each of the plurality of the modular batteries, comprising at least one accessory input mechanism and having a wireless transmitter component configured to wirelessly transmit input data therefrom to the wireless receiver component in at least one of the plurality of modular batteries.

10. The modular battery system of claim 9, wherein the power management circuit is configurable in a battery lifespan extending mode in which power is drawn alternately or in parallel from at least two modular batteries so as to deplete the power more uniformly, and wherein the power management circuit prevents depletion of any one of the at least two modular batteries below a predetermined charge threshold while charge remains available in another of the at least two modular batteries.

11. The modular battery system of claim 9, wherein each of the plurality of modular batteries comprises a printed circuit board with a microcontroller and a fuel gauge integrated circuit configured to track charge cycle count and store usage data in on-board memory, the usage data being communicated to the power management circuit to provide battery usage recommendations to a user.

12. The modular battery system of claim 9, wherein wireless communication between the wireless transmitter component and the wireless receiver component occurs via at least one of LAN, Wi-Fi or Bluetooth.

13. The modular battery system of claim 9, wherein the at least one accessory input mechanism is configured as a wireless controller comprising at least one of a touchpad, a touchscreen, a display screen, an inertial measurement unit, an optical mouse sensor, a scroll wheel, one or more buttons, and/or one or more switches.

14. The modular battery system of claim 9, wherein at least one of the plurality of modular batteries includes an inertial measurement unit (IMU) configured to provide gesture-based or orientation-based control input to the processor of the personal computing device.

15. A modular accessory system for smart glasses, the system comprising:
smart glasses containing a central processing unit and a display;
one or more modular accessory devices configured to be selectively attached to and detached from one or more temple arms of the smart glasses, wherein the one or more modular accessory devices include power storage cells;
one or more connection terminals on each of the one or more modular accessory devices providing at least one power connection and at least one data connection to the central processing unit in the smart glasses; and
an accessory storage case configured to store and charge the one or more modular accessory devices and comprising at least one input mechanism configured to function as a wireless input controller for the CPU of the smart glasses, wherein each of the one or more modular accessory devices comprises a wireless communication component configured to wirelessly communicate with both the at least one input mechanism and the central processing unit.

16. The modular accessory system of claim 15, wherein each modular accessory device is attached to the smart glasses by at least one of a magnetic connection or a mechanical locking mechanism, and wherein the power connection and the data connection are established via inductive coupling or spring-loaded contact pins.

17. The modular accessory system of claim 15, wherein at least one of the one or more modular accessory devices includes a microphone, such that the modular accessory device is configured to function as a lavalier microphone that wirelessly transmits audio data to the CPU of the smart glasses.

18. The modular accessory system of claim 15, wherein at least one of the one or more modular accessory devices or the accessory storage case includes an inertial measurement unit (IMU) configured to enable pointer orientation for the display of the smart glasses, detect gesture inputs for on display selection, or provide motion-based input commands to the CPU.

19. The modular accessory system of claim 15, wherein the at least one input mechanism of the accessory storage case comprises one or more of: a touchpad, a touchscreen, a display screen, an inertial measurement unit, an optical mouse sensor, a scroll wheel, one or more buttons, and one or more switches.

20. The modular accessory system of claim 15, wherein the smart glasses, the one or more modular accessory devices, and the accessory storage case are each further configured to wirelessly communicate with a mobile computing device associated with a user of the smart glasses.
